(19) United States
(12) Patent Application Publication
(10) Pub. No.: US 2015/0257403 A1
(43) Pub. Date: Sep. 17, 2015

(54) OIL-IN-WATER EMULSION COMPRISING DEAMIDATED PROTEIN

(71) Applicant: NESTEC S.A., Vevey (CH)

(72) Inventors: Juan Sanz-Valero, Columbus, OH (US); Pu-Sheng Cheng, Dublin, OH (US); Teresita Bautista Pascual, Marysville, OH (US)

(21) Appl. No.: 14/418,546

(22) PCT Filed: Aug. 8, 2013
(86) PCT No.: PCT/EP2013/066647

§ 371 Date: Jan. 30, 2015

Related U.S. Application Data
(60) Provisional application No. 61/681,719, filed on Aug. 10, 2012.

(51) Int. Cl. A23C 13/12; A23D 7/005

(52) U.S. Cl. CPC A23C 13/125; A23D 7/0053; A23V 2002/00

(57) ABSTRACT

The present invention relates to oil-in-water emulsions, e.g. in the form of food or beverage compositions or ingredients for food or beverage compositions, such as creamers. The oil-in-water emulsions comprise deamidated protein as emulsifier. The invention also relates to a method of producing an oil-in-water emulsion comprising deamidated protein.

### FIELD OF THE INVENTION

The present invention relates to field of oil-in-water emulsions, e.g. in the form of food or beverage compositions or ingredients for food or beverage compositions, such as creamers. The oil-in-water emulsions comprise deamidated protein as emulsifier.

### BACKGROUND

Oil-in-water emulsions have many uses, for example many food and beverage products are, or contain, oil-in-water emulsion. The stability of such products is of great importance. Examples of oil-in-water emulsions are creamers. Creamers are widely used as whitening agents with hot and cold beverages such as, for example, coffee, cocoa, tea, etc. They are commonly used in place of milk and/or dairy cream. Creamers may come in a variety of different flavors and provide mouthfeel, body, and a smoother texture. Creamers can be in liquid or powder forms. A liquid creamer may be intended for storage at ambient temperatures or under refrigeration, and should be stable during storage without phase separation, creaming, gelation and sedimentation. The creamer should also retain a constant viscosity over time. When added to cold or hot beverages such a coffee or tea, the creamer should dissolve rapidly, provide a good whitening capacity, and remain stable with no feathering and/or sedimentation while providing a superior taste and mouthfeel. Emulsions and suspensions are not thermodynamically stable, and there is a real challenge to overcome physico-chemical instability issues in the liquid creamers that contain oil and other insoluble materials, especially for the aseptic liquid creamers during long storage times at ambient or elevated temperatures. Moreover, over time, creaming that can still be invisible in the liquid beverages stored at room and elevated temperatures can cause a plug in the bottle when refrigerated. Emulsifiers are used to stabilise emulsions, such as oil-in-water emulsions. A variety of emulsifiers, both natural and synthetic, exist, but it may still be a challenge to achieve the desired stability of emulsions during storage and use. Conventionally, low molecular weight emulsifiers, such as e.g. mono- and diglycerides, are added to non-dairy liquid creamers to ensure stability of the oil-in-water emulsion. Low molecular weight emulsifiers are effective stabilisers of the oil-in-water emulsion, but may be perceived as artificial by consumers.

WO 2011/108633 discloses creamer compositions comprising deamidated casein. The objects of the invention is to provide oil-in-water emulsions that are stable, by using emulsifiers that are perceived as being natural, as well as improved methods of producing these. Specifically, the invention aims to provide improved methods for producing oil-in-water emulsions with deamidated casein, e.g. by performing the deamidation as an integrated step of the preparation of the emulsion, and preparation of emulsions with a lower degree of deamidation than used in the prior art. Using a lower degree of deamidation has the advantage of reducing the use of reactants, e.g.

enzyme, and/or the duration of the treatment. The products of the invention are e.g. useful as creamer compositions, e.g. low fat creamer compositions.

### SUMMARY OF THE INVENTION

In a first aspect, the invention relates to an oil-in-water emulsion comprising an oil, a protein which has been deamidated to a degree of at least about 5%, and an aqueous phase. In a further aspect, the invention relates to a powder prepared by drying an oil-in-water emulsion of the invention, and in still further aspects to methods for preparing an oil-in-water emulsion and a powder of the invention.

### DETAILED DESCRIPTION OF THE INVENTION

According to the present invention an oil-in-water emulsion is provided which has a good physical stability without the need for low molecular weight emulsifiers. By physical stability is meant stability against phase separation, plug formation, flocculation and/or aggregation of fat due to fat crystallization and/or formation of an oil rich fraction in the upper part of the composition due to aggregation and/or coalescence of oil droplets, e.g. aggregation and/or coalescence of oil droplets to form a hard “plug” in the upper part of the product. An oil-in-water emulsion of the invention is preferably a food or beverage product, and/or an ingredient to be used in a food and beverage product. In a preferred embodiment, an oil-in-water emulsion is a creamer composition.

By a creamer composition is meant a composition that is intended to be added to a food composition, such as e.g. coffee or tea, to impart specific characteristics such as colour (e.g. whitening effect), thickening, flavour, texture, and/or other desired characteristics. A creamer composition of the invention is preferably in liquid form, but may also be in powdered form.

The oil-in-water emulsion of the invention comprises oil. The oil may be any oil, or combination oils. If the oil-in-water emulsion is a food or beverage product, such as a creamer, the oil should be suitable for human consumption in a liquid creamer. The oil is preferably a vegetable oil, such as e.g. oil from canola, soy bean, sunflower, safflower, cotton seed, palm oil, palm kernel oil, corn, and/or coconut. The oil is preferably present in an amount of between about 0.5% and about 60% (weight/weight), such as e.g. between about 1% and about 40% (weight/weight), or between about 1% and about 20% (weight/weight). In another embodiment, the oil-in-water emulsion of the invention comprises less than 10% oil (weight/weight), such as e.g. between 1% and 9% oil (weight/weight).

The oil-in-water emulsion of the invention further comprises protein which has been deamidated to a degree of at least 5%. The oil-in-water emulsion preferably comprises between about 0.1% (weight/weight) and about 5% protein which has been deamidated, such as between about 0.2% (weight/weight) and about 4% protein which has been deamidated, more preferably between about 0.5% (weight/weight) and about 3% protein which has been deamidated. The protein may be any suitable protein, e.g. milk protein, such as casein and whey protein; vegetable protein, e.g. soy and/or pea protein; and/or combinations thereof. The protein is preferably casein. By casein is meant casein in any suitable form, e.g. in the form of caseinate, such as e.g. sodium caseinate. By deamidated is meant that amide groups of the protein are converted to carboxyl groups, converting glutaminyl residues in the protein into glutamyl acid residues. The protein may be deamidated by any suitable method known in the art. The deamidation is preferably performed without substantial cross-linking of the protein, or substantial cleavage of peptide bonds. The protein is deamidated to a degree of at least 5%. In a preferred embodiment, the protein is deamidated to a degree of less than 70%. In a further preferred embodiment the protein is deamidated to a degree of between about 10% and about 65%, such as between about 30% and about 60%. Deamidation is preferably performed by treating the protein with an enzyme capable of deamidating said protein. The use of enzymes in protein deamidation has several advantages over chemical modification, including greater reaction rate, mild reaction, food safety and, most importantly, high substrate specifity.

Degree of deamidation as used herein is defined as the degree of conversion of protein glutamine residues amide groups to carboxyl groups with the concomitant release of ammonia, converting glutamine residues in the protein into glutamic acid residues. The degree of deamidation can be expressed as the ratio of the amount of released ammonia by the deamidation treatment of the protein and the ammonia released when the protein is completely deamidated by treatment with 2N sulphuric acid at 100° C. for 8 h (Inthawoot Suppavosatit, Elvira Gonzalez De Mejia, and Keith R. Cadwallader. Optimization of the enzymatic deamidation of soy protein by protein-glutaminase and its effect on the functional properties of the protein. Journal of Agric. Food Chem. 2001, 59, 11621-11628).

Enzymes

Enzymes useful for deamidating protein in accordance with the present invention are any enzymes capable of deamidating the protein to be used, without creating substantial cross-linking of proteins, or substantial cleavage of peptide bonds. Peptidoglutaminase, as well as a combination of protease and protein glutaminase are known to be useful for the deamidation of food proteins. Protein glutaminase (E.C.3.5.1.44) (also referred to as protein-glutamine glutaminase, glutaminylpeptide glutaminase, or peptidoglutaminase II) appears to be the most attractive enzyme since it does not cause side reaction, such as crosslinking or peptide hydrolysis. Japanese laid-open patent application (Kokai) No. 2000-50887 and Japanese laid-open patent application (Kokai) No. 2001-21850 disclose enzymes useful for performing deamidation of protein according to the invention. A commercial enzyme useful for deamidation according to the invention is Amano 500 K Protein-glutaminase derived from Chryseobacterium proteolyticum (E.C.3.5.1.44) (Amano Enzymes). The enzyme to be used is preferably not a transglutaminase (EC 2.3.2.13), and preferably do not have substantial transglutaminase activity, as transglutaminase activity may result in undesirable cross-linking of proteins. EC (Enzyme Committee) numbers refer to the nomenclature of enzymes defined by the Nomenclature Committee of the International Union of Biochemistry and Molecular Biology (IUBMB).

Low Molecular Weight Emulsifiers

In one embodiment of the invention, the oil-in-water emulsion is devoid of added low molecular weight emulsifiers. By a low molecular weight emulsifier is meant an emulsifier with a molecular weight below 1500 g/mol Emulsions are thermodynamically unstable, and the phases of an emulsion will separate with time. By an emulsifier is meant a compound that stabilises the interface between the two phases of the oil-in-water emulsion and reduces the rate of phase separation. By the term “devoid of added low molecular weight emulsifiers” is meant that the oil-in-water emulsion does not contain any low molecular weight emulsifiers which have been added in amounts sufficient to substantially affect the stability of the emulsion. An oil-in-water emulsion devoid of added low molecular weight emulsifiers may contain minor amounts of low molecular weight emulsifiers which do not substantially affect the stability of the emulsion, but which are present e.g. as minor impurities of one or more of the ingredients of the oil-in-water emulsion.

Low molecular weight emulsifiers include, but are not limited to, monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol mono laurate, sorbitan monostearate, sodium stearoyl lactylate, calcium stearoyl lactylate, glycerol sorbitan monopalmitate, diacetylated tartaric acid esters of monoglycerides and diglycerides, succinic acid esters of mono- and diglycerides, lactic acid esters of mono- and diglycerides, lecithins, lysolecitins, and sucrose esters of fatty acids.

In one embodiment an oil-in-water emulsion according to the invention is devoid of added monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol mono laurate, sorbitan monostearate, sodium stearoyl lactylate, calcium stearoyl lactylate, glycerol sorbitan monopalmitate, diacetylated tartaric acid esters of monoglycerides and diglycerides, succinic acid esters of mono- and diglycerides, lactic acid esters of mono- and/or diglycerides, and sucrose esters of fatty acids, lecithin and lysolecithins, indcluding lecithin and/or lysolecithin derived from soy, canola, sunflower, and/or safflower.

The oil-in-water emulsion of the invention further comprises an aqueous phase. An aqueous phase according to the invention may be pure water, or may be water comprising any other suitable component which is desired in the oil-in-water emulsion, depending on the desired characteristics and the intended use. If the oil-in-water emulsion is a food or beverage product, e.g. a creamer, the aqueous phase may e.g. comprise any component mentioned herein as suitable ingredients of such compositions.

The oil-in-water emulsion of the present invention may further include a buffering agent, e.g. as part of the aqueous phase. The buffering agent can prevent undesired creaming or precipitation of the oil-in-water emulsion upon addition into a hot, acidic environment, e.g. when a creamer is added to a beverage such as coffee. The buffering agent can e.g. be monophosphates, diphosphates, sodium mono- and bicarbonates, potassium mono- and bicarbonates, or a combination thereof. Preferred buffers are salts such as potassium phosphate, dipotassium phosphate, potassium hydrophosphate, sodium bicarbonate, sodium citrate, sodium phosphate, disodium phosphate, sodium hydrophosphate, and sodium tripolyphosphate. The buffer may e.g. be present in an amount of about 0.1 to about 1% by weight of the oil-in-water emulsion.

The oil-in-water emulsion of the present invention may further include one or more additional ingredients, specifically if the oil-in-water emulsion is a food or beverage product, e.g. a creamer, it may comprise ingredients such as flavors, sweeteners, colorants, antioxidants (e.g. lipid antioxidants), or a combination thereof Sweeteners can include, for example, sucrose, fructose, dextrose, maltose, dextrin, levulose, tagatose, galactose, corn syrup solids and other natural or artificial sweeteners. Sugarless sweeteners can include, but are not limited to, sugar alcohols such as maltitol, xylitol, sorbitol, erythritol, mannitol, isomalt, lactitol, hydrogenated starch hydrolysates, and the like, alone or in combination. Usage level of the flavors, sweeteners and colorants will vary greatly and will depend on such factors as potency of the sweetener, desired sweetness of the product, level and type of flavor used and cost considerations. Combinations of sugar and/or sugarless sweeteners may be used. In one embodiment, a sweetener is present in the oil-in-water emulsion of the invention at a concentration ranging from about 5% to about 40% by weight. In another embodiment, the sweetener concentration ranges from about 25% to about 30% by weight.

The oil-in-water emulsion of the invention is preferably a food or beverage product, or an ingredient of a food or beverage product. A food or beverage product may be any product intended for consumption by a human, e.g. a dairy product, a dairy beverage, and/or a creamer composition. In a preferred embodiment, the oil-in-water emulsion is a creamer composition.

Powder

The present invention further relates to a powder prepared by drying an oil-in-water emulsion of the invention. Drying may be performed in any suitable way, such as e.g. by spray drying or freeze drying. Spray drying and freeze drying are technologies well known in the art for drying liquid products, e.g. emulsions, to produce powdered products, such as e.g. powdered food and beverage products. In a preferred embodiment, a powder according to the invention is a powdered creamer composition.

Method

The present invention also relates to a method of preparing oil-in-water emulsion, comprising: a) providing an oil; b) providing a protein; c) providing an aqueous liquid; d) mixing said oil, said protein, and said aqueous liquid, to provide an aqueous suspension of oil and protein; and e) treating said aqueous suspension of oil and protein with an enzyme capable of deamidating the protein.

The inventors have found that this method is advantageous over methods wherein protein is deamidated separately before being mixed with an oil. It is thus important in the method of the invention that (at least part of) the treatment is performed while both oil and protein is present in an aqueous suspension.

The protein may be any suitable protein as disclosed herein, and may be provided in any suitable form, e.g. as a powder, granulate or a solution. The oil may be any suitable oil as mentioned herein, and may be provided in liquid or solid form. The aqueous liquid may be any aqueous liquid, e.g. an aqueous phase as disclosed herein.

The oil, protein and aqueous liquid may be mixed in any suitable way to provide an aqueous suspension of oil and protein. Normally, before mixing the oil will be present in liquid form, but it could also be provided in solid form and melted in the liquid during mixing. Methods and apparatus for mixing the components of oil-in-water emulsions, e.g. food or beverage emulsions, are well known in the art, and any suitable method may be used. The oil, protein and aqueous liquid may be mixed in any order, e.g. all three components may be mixed simultaneously, or the protein may be mixed the aqueous liquid before oil is introduced into the liquid. Any additional components may be present in the aqueous liquid before mixing, or may be mixed into the suspension at any appropriate time, e.g. before, during, and/or after the treatment with an enzyme.

The liquid suspension of oil and protein is treated with an enzyme capable of deamidating the protein. The enzyme may be any such enzyme as disclosed herein. It is important that the treatment is, at least partly, carried out while both protein and oil is present. Normally, the enzyme will be added to the liquid suspension of oil and water. It is also possible to e.g. add the enzyme to the aqueous liquid before mixing; or to a mixture of the protein and the aqueous liquid before the oil is added, and then add the oil subsequently and continue the enzymatic reaction with the oil present. The treatment may be carried out in any suitable way, depending e.g. on the characteristics of the enzyme. Methods for performing enzymatic treatments are well known in the art. The enzyme may be in any suitable form, e.g. in the form of a powder, liquid solution, or immobilised unto a solid support. Conditions such as temperature and time may be readily determined and optimised by the skilled person to achieve the desired result. Treatment temperature may typically be between about 5° C. and about 60° C., such as e.g. between about 30° C. and about 60° C. Treatment time may vary according to the amount of enzyme, activity of the enzyme, and the desired degree of deamidation, but may typically be between about 15 minutes and about 10 hours, such as e.g. between about 30 minutes and about 5 hours. When the desired degree of deamidation has been reached, the enzymatic reaction may be stopped by any suitable method. If the enzyme is immobilised, the enzyme and the liquid suspension may e.g. be separated to stop the enzymatic reaction, if the enzyme is in powder or liquid form and added to the suspension, the reaction may be stopped by e.g. cooling the suspension to a temperature where the enzymatic activity is negligible, or the enzyme may be inactivated, e.g. by heat treatment, e.g. at between about 70° C. and about 100° C. for between about 30 seconds and 1 hour, depending on the characteristics of the enzyme. In a preferred embodiment, the method of the invention comprises inactivation of the enzyme capable of deamidating the protein after the treatment of the aqueous suspension.

The oil-in-water emulsion may be homogenised by any suitable method, e.g. before, during, or after the enzymatic treatment, to reduce oil droplet size and increase stability of the emulsion.

In a preferred embodiment, the present invention relates to a method of preparing an oil-in-water emulsion, comprising: a) providing an oil; b) providing a protein; c) providing an aqueous liquid; d) mixing said oil, said protein, and said aqueous liquid, to provide an aqueous suspension of oil and protein; and e) treating said aqueous suspension of oil and protein with an enzyme capable of deamidating the protein; wherein the oil constitutes between 1% and 9% (weight/weight) of the oil-in-water emulsion, and the treatment in step e) is conducted until a degree of deamidation of between about 10% and about 65% has been reached.

In a preferred embodiment, the oil-in-water emulsion prepared by the method of the invention is a creamer composition.

In a further embodiment, the invention relates to a method for preparing a powder of the invention, by drying an oil-in-water emulsion prepared by a method of the invention. Drying may be performed in any suitable way, e.g. by spray drying or freeze drying. The oil-in-water emulsion to be dried is preferable prepared by mixing oil, protein, aqueous phase, and optionally other ingredients, in proportions to yield a water content of less than 50% by weight, more preferably less than 40% by weight.

By keeping the amount of water low, less energy is needed for the drying process.

In a preferred embodiment, the powder prepared by the method of the invention is a powdered creamer composition.

### EXAMPLES

### Example 1

Liquid coffee creamer with in-situ enzyme treated emulsifier production using different enzyme concentrations. The percentage of all ingredients refer to percentage of the total weight unless otherwise stated.

Objective: The in-situ production of enzyme treated sodium caseinate with different deamidation degree (DD) as emulsifier in liquid coffee creamer was evaluated. A commercial enzyme, protein glutaminase (Amano 500K) derived from Chryseobacterium proteolyticum provided by Amano was used for this propose. Three different enzyme concentrations were used to obtain different deamidation degrees of sodium caseinate: 1% w/w (37% DD), 2% w/w (51% DD) and 3% w/w (63% DD) (based on sodium caseinate weight).

Methodology:

The degree of deamidation (DD) of sodium caseinate was determined by using an ammonia assay kit (Sigma-Aldrich, St. Louis, Mo.) to determine the amount of ammonia released from deamidated glutamine residues. The DD was expressed as the ratio (in percentage) of the amount of ammonia released by treatment of sodium caseinate with protein glutaminase and the amount of ammonia released when the protein was treated with 2N sulphuric acid at 100° C. for 8 h (Inthawoot Suppavosatit, Elvira Gonzalez De Mejia, and Keith R. Cadwallader. Optimization of the enzymatic deamidation of soy protein by protein-glutaminase and its effect on the functional properties of the protein. Journal of Agric. Food Chem. 2001, 59, 11621-11628).

Procedure for Ammonia Determination in Sodium Caseinate

The ammonia release in the samples was determined by using an ammonia kit from Sigma-Aldrich. The principal of the methodology is an enzymatic reaction in which the samples reacts with a-ketoglutaric acid (KGA) and reduced nicotinamide adenine dinucleotide phosphate (NADPH) in the presence of the enzyme L-Glutamate dehydrogenase (GDH) to form L-glutamate and oxidized nicotinamide adenine dinucleotide phosphate (NADP⁺). The decrease in absorbance at 340 nm, due to the oxidation of NADPH, is proportional to the ammonia concentration.

The procedure is as follows:
1—Reconstitute ammonia assay reagent with 10 mL of water (the reagent contains α-ketoglutaric acid, NADPH, buffers, stabilizers, and nonreactive fillers).
2—Samples should be diluted with water to an ammonia concentration of 0.2-15 μg/mL with a final sample volume of 0.1 mL.
3—Mix 1 mL of reagent with 0.1 mL of sample in a cuvette by inverting 5 times. Incubate for 5 minutes at room temperature and read absorbance at 340 nm.
4—Add 10 μL of L-Glutamate dehydrogenase to the cuvette.
5—Mix the content of the cuvette by inverting 5 times. Let incubate at room temperature for 5 min, and read absorbance at 340 nm.

The stability of the liquid coffee creamer was determined by the free oil observed in cup when creamer was added to coffee in a ratio (1/6) which indicated a destabilization of the product.

Process: In-situ production of enzyme treated/untreated sodium caseinate in liquid coffee creamer was prepared as follow:
The ingredients: Buffer (0.4% w/w dipotassium phosphate (Univar USA Inc.)), sodium caseinate (Alanate 180, Fonterra USA Inc.) (1.5% w/w) and partially hydrogenated soybean and cottonseed oil (8.4% w/w) (Team Whip, Bunge oils, St Louis Mo., USA) were mixed with water at 70° C.
Solution was cooled down to 50° C. and then enzyme protein glutaminase was added in a concentration of 1%, 2% or 3% w/w based on the sodium caseinate content when enzyme treatment was required.
Reaction was allowed for 1 h.
Solution was homogenized at 200 bars (second stage 50/ first stage 150 bars)
Solution was pasteurized at 90° C. for 10 min, which in this case was also used to inactivate the enzyme.
Final solution was cooled in ice bath for 5 min.

Results: When liquid coffee creamer containing only non treated sodium caseinate as emulsifier was added to hot coffee in a ratio (1/6) it was observed a physical destabilization of the product in the form of free oil formation in cup. However, in the liquid creamer samples containing enzymatic treated sodium caseinate produced in-situ at all different deamidation degrees (41%, 50% and 60%) no oil formation was observed in cup.

### Example 2

Liquid coffee creamer with in-situ enzyme treated emulsifier production using different sodium caseinate concentrations

Objective: The in-situ production of enzyme treated sodium caseinate at different concentrations as emulsifier in liquid coffee creamer was evaluated. Three different sodium caseinate concentrations were enzymatically treated: 0.9% (w/w), 1.2% (w/w) and 1.5% (w/w) during the production of liquid coffee creamer.

Methodology: The stability of liquid coffee creamer was tested as described in example 1.

Process: In-situ production of enzyme treated/untreated sodium caseinate in liquid coffee creamer was performed as follow:
The ingredients: buffer (0.4% w/w dipotassium phosphate), sodium caseinate (1.5% w/w, 1.2% w/w or 0.9% w/w) and partially hydrogenated soybean and cottonseed oil (8.4% w/w) were mixed with water at 70° C.
Solution was cooled down to 50° C. and then enzyme protein glutaminase (as in example 1) was added in a concentration of 3% w/w based on the sodium caseinate content when enzyme treatment was required.
Reaction was allowed for 1 h.
Solution was homogenized at 200 bars (second stage 50/first stage 150 bars)
Solution was pasteurized at 90° C. for 10 min, which in this case was also used to inactivate the enzyme.
Final solution was cooled in ice bath for 5 min.

Results: When liquid coffee creamer containing only non treated sodium caseinate was added to hot coffee in a ratio (1/6) it was observed a physical destabilization of the product in the form of free oil formation in cup. However, in the liquid creamer sample containing enzymatic treated sodium caseinate at all different concentrations produced in-situ no oil formation was observed in cup.

### Example 3

Liquid coffee creamer with in-situ enzyme treated emulsifier production using different oil concentrations

Objective: The in-situ production of enzyme treated sodium caseinate as emulsifier in liquid coffee creamer was evaluated using oil concentrations. Three different oil concentrations were used to prepare the liquid coffee creamer: 4% (w/w), 8.4% (w/w) and 12% (w/w).

Methodology: The stability of liquid coffee creamer was tested as described in example 1.

Process: In-situ production of enzyme treated/untreated sodium caseinate in liquid coffee creamer was prepared as follow:
The ingredients: buffer (0.4% w/w dipotassium phosphate), sodium caseinate (1.5% w/w) and partially hydrogenated soybean and cottonseed oil (12% w/w, 8.4% w/w or 4% w/w) were mixed with water at 70° C.
Solution was cooled down to 50° C. and then enzyme protein glutaminase was added in a concentration of 3% w/w based on the sodium caseinate content when enzyme treatment was required.
Reaction was allowed for 1 h.
Solution was homogenized at 200 bars (second stage 50/first stage 150 bars)
Solution was pasteurized at 90° C. for 10 min, which in this case was also used to inactivate the enzyme.
Final solution was cooled in ice bath for 5 min.

Results: When liquid coffee creamer containing only non treated sodium caseinate was added to hot coffee in a ratio (1/6) it was observed a physical destabilization of the product in the form of free oil formation in cup. However, in the liquid creamer sample containing enzymatic treated sodium caseinate produced in-situ with different oil content no oil formation was observed in cup.

### Example 4

Production of enzyme treated sodium caseinate as an emulsifier ingredient for liquid creamer

Objective: The enzymatic modification of sodium caseinate was evaluated to produce a natural emulsifier for creamers. A commercial enzyme protein glutaminase (Amano 500K) derived from Chryseobacterium proteolyticum provided by Amano was used for this propose.

Enzyme treatment: Sodium caseinate (10% w/w) was treated in aqueous solution with protein glutaminase (3% w/w) based on caseinate content for 1 h at 50° C. Proper mixing was achieved by using a shaker incubator at 200 rpm. After the enzymatic reaction, the enzyme was deactivated by heating the solution at 90° C. for 10 min.

Process: Emulsions for liquid creamer bench samples containing sodium caseinate w/wo enzymatic treatment were prepared as follow:
Buffer (dipotassium phosphate 0.4% w/w) and sodium caseinate treated/untreated (1.5% w/w), were mixed with water at 70° C.
Melted partially hydrogenated soybean and cottonseed oil (8.4% w/w), was added and mixed with previous ingredients.
Emulsion solution was homogenized at 200 bars (second stage 50/first stage 150 bars)
Emulsion solution was pasteurized at 90° C. for 10 min and then cooled in ice bath for 5 min.

Results: When liquid coffee creamer containing only non treated sodium caseinate was added to hot coffee in a ratio (1/6) it was observed a physical destabilization of the product in the form of free oil formation in cup. However, in the liquid creamer sample containing enzymatic treated sodium caseinate, no oil formation was observed in cup.

1. An oil-in-water emulsion comprising: an oil, a protein which has been deamidated to a degree of at least about 5%, and an aqueous phase.

2. The oil-in-water emulsion of claim 1, wherein the protein has been deamidated to a degree of less than 70%.

3. The oil-in-water emulsion of claim 1, wherein the protein has been deamidated to a degree of between about 10% and about 65%.

4. The oil-in-water emulsion of claim 1, comprising less than 10% oil.

5. The oil-in-water emulsion of claim 1, wherein the protein which has been deamidated is milk protein.

6. The oil-in-water emulsion of claim 5, wherein the milk protein is casein.

7. The oil-in-water emulsion of claim 1, wherein the protein has been deamidated by treatment with an enzyme capable of deamidating the protein.

8. The oil-in-water emulsion of claim 1, wherein the protein has been deamidated by treatment with a protein glutaminase (E.C.3.5.1.44).

9. The oil-in-water emulsion of claim 1, being devoid of not including added low molecular weight emulsifiers.

10. The oil-in-water emulsion of claim 1 being a creamer.

11. A powder prepared by drying an oil-in-water emulsion comprising an oil, a protein which has been deamidated to a degree of at least about 5%, and an aqueous phase.

12. A method of preparing an oil-in-water emulsion, comprising:
a) providing an oil;
b) providing a protein;
c) providing an aqueous liquid;
d) mixing the oil, the protein, and the aqueous liquid, to provide an aqueous suspension of oil and protein; and
e) treating the aqueous suspension of oil and protein with an enzyme capable of deamidating the protein.

13. The method of claim 12, wherein the treatment in step e) is conducted until the protein has been deamidated to a degree of less than 70%.

14. The method of claim 12, wherein the enzyme is not a transglutaminase.

15. A method of preparing a powder, the method comprising: drying an oil-in-water emulsion prepared by
providing an oil;
providing a protein;
providing an aqueous liquid;
mixing the oil, the protein, and the aqueous liquid, to provide an aqueous suspension of oil and protein; and
treating the aqueous suspension of oil and protein with an enzyme capable of deamidating the protein.
